(19) United States
(12) Patent Application Publication
(10) Pub. No.: US 2025/0065644 A1
(43) Pub. Date: Feb. 27, 2025

(54) IMAGE FORMING APPARATUS INCLUDING OPTICAL SCANNING APPARATUS

(71) Applicant: CANON KABUSHIKI KAISHA, Tokyo (JP)

(72) Inventor: HIROYUKI FUKUHARA, Shizuoka (JP)

(21) Appl. No.: 18/746,526

(22) Filed: Jun. 18, 2024

(30) Foreign Application Priority Data
Jun. 20, 2023 (JP) 2023-101182

(51) Int. Cl. B41J 2/47; B41J 2/44; G02B 26/12; G03G 15/04; G03G 15/041

(52) U.S. Cl. CPC B41J 2/471; B41J 2/44; G02B 26/127; G03G 15/04036; G03G 15/0415

(57) ABSTRACT

An image forming apparatus includes an optical scanning apparatus configured to scan a photoreceptor with a light beam having a scanning speed changing in accordance with a position in a main scanning direction, and a control unit configured to output a horizontal synchronization signal for determining a timing at which an image signal generation unit outputs an image signal to the optical scanning apparatus. The optical scanning apparatus includes a beam detection sensor that outputs a beam detection signal indicating a detection timing of the light beam, and a memory that stores timing correction information. The control unit corrects, based on the timing correction information, a reference time, and outputs the horizontal synchronization signal to the image signal generation unit at a timing after a period corrected from reception of the beam detection signal.

### BACKGROUND OF THE INVENTION

### Field of the Invention

The present invention relates to an electrophotographic image forming apparatus.

### Description of the Related Art

An electrophotographic image forming apparatus forms an electrostatic latent image on a photoreceptor by repeatedly scanning and exposing, with scanning light emitted based on image data, the photoreceptor that is rotationally driven. The electrostatic latent image is developed with a developer such as toner, whereby a toner image (image by toner) is formed on the photoreceptor. The image forming apparatus includes an optical scanning apparatus including a scanning lens for condensing scanning light on the photoreceptor and a rotary polygon mirror for moving scanning light in a main scanning direction. The main scanning direction is a direction parallel to a rotation axis of the photoreceptor. The trajectory of the scanning light on the photoreceptor is referred to as a scanning line, and the moving speed of the scanning light on the photoreceptor is referred to as a scanning speed. A color image forming apparatus is provided with photoreceptors respectively associated with a plurality of colors used for image formation.

In the image forming apparatus, a horizontal synchronization signal is used to determine timing to start scanning (hereinafter, scanning start timing) of the photoreceptor. Hereinafter, a position in the main scanning direction of the photoreceptor scanned with scanning light at the scanning start timing is described as a scanning start position. The scanning start position is a position where formation (writing) of an electrostatic latent image is started in scanning of the photoreceptor, and can also be referred to as a formation start position. If the actual scanning start position is different from the target position thereof, color deviation is caused. Japanese Patent Laid-Open No. 2009-300604 discloses a configuration in which a period from generation timing of a horizontal synchronization signal to scanning start timing is measured and stored in advance for each image forming apparatus. Japanese Patent Laid-Open No. 2009-300604 discloses a technique for measuring write timing with reference to a horizontal synchronization signal of a laser beam in an optical scanning apparatus in advance in order to correct a scanning start position, and storing a measurement result into the image forming apparatus as correction information.

However, in a case where the scanning start position is corrected with reference to the horizontal synchronization signal, if the timing of the horizontal synchronization signal deviates from the ideal due to an assembly variation of the optical scanning apparatus, an attachment error of the sensor, or the like, this can cause an image defect.

### SUMMARY OF THE INVENTION

According to an aspect of the present invention, an image forming apparatus includes: a photoreceptor that s rotationally driven; an image signal generation unit configured to generate an image signal based on image data; an optical scanning apparatus configured to scan the photoreceptor with a light beam having a scanning speed changing in accordance with a position in a main scanning direction, the optical scanning apparatus configured to form an electrostatic latent image on the photoreceptor by scanning the photoreceptor in the main scanning direction with a light beam corresponding to the image signal generated by the image signal generation unit; and a control unit configured to output, to the image signal generation unit, a horizontal synchronization signal for determining a timing at which the image signal generation unit outputs the image signal to the optical scanning apparatus. The optical scanning apparatus includes a light source that emits the light beam, a rotary polygon mirror for scanning the photoreceptor in the main scanning direction by the light beam emitted by the light source, a beam detection sensor that detects the light beam reflected by the rotary polygon mirror and outputs, to the control unit, a beam detection signal indicating a detection timing of the light beam, and a memory that stores timing correction information indicating a deviation amount of an output timing of the beam detection signal. The control unit corrects, based on the timing correction information acquired from the memory, a reference time from reception of the beam detection signal from the beam detection sensor to output of the horizontal synchronization signal, and outputs the horizontal synchronization signal to the image signal generation unit at a timing after a period corrected from reception of the beam detection signal.

Further features of the present invention will become apparent from the following description of exemplary embodiments with reference to the attached drawings.

### BRIEF DESCRIPTION OF THE DRAWINGS

FIG. 1 is a configuration diagram of an image forming apparatus according to an embodiment.

FIGS. 2A and 2B are configuration diagrams of an optical scanning apparatus according to an embodiment.

FIG. 3 is a view illustrating a relationship between an image height and partial magnification according to an embodiment.

FIG. 4 is a view illustrating an exposure control configuration.

FIG. 5 is a block diagram of a modulation unit according to an embodiment.

FIGS. 6A and 6B are explanatory views of halftone processing according to an embodiment.

FIG. 7 is a timing chart of partial magnification correction and luminance correction according to an embodiment.

FIG. 8 is an explanatory view illustrating deviation of timing of a BDI signal due to an arrangement error of a BD sensor.

FIG. 9 is an explanatory view illustrating deviation of timing of a horizontal synchronization signal due to an arrangement error of a BD sensor.

FIGS. 10A and 10B are explanatory views of an influence in a case where timing of the horizontal synchronization signal deviates.

FIG. 11 is a view illustrating an exposure control configuration according to an embodiment.

FIG. 12 is an explanatory view illustrating not shifting timing of a horizontal synchronization signal even when timing of a BDI signal deviates.

FIG. 13 is a timing chart of partial magnification correction and density correction according to an embodiment.

FIG. 14 is a view illustrating an example of frequency correction information according to an embodiment.

FIG. 15 is a block diagram of a modulation unit according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

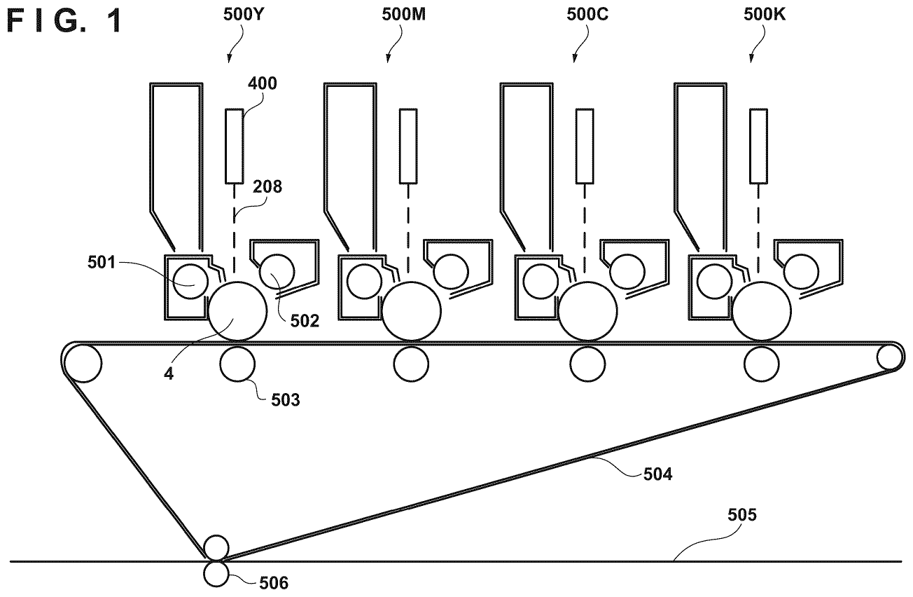

FIG. 1 is a schematic configuration diagram of an image forming apparatus according to the present embodiment. In each of the following drawings, for simplification of description, components that are not necessary for understanding of the embodiment are omitted from the drawings. Image forming units 500Y, 500M, 500C, and 500K form toner images of yellow, magenta, cyan, and black, respectively, on an intermediate transfer body 504. The image forming units 500Y, 500M, 500C, and 500K form toner images on the intermediate transfer body 504 in an overlapping manner, whereby colors different from yellow, magenta, cyan, and black can be reproduced. The configurations of the image forming units 500Y, 500M, 500C, and 500K are similar, and include a photoreceptor 4, a charge roller 502, an optical scanning apparatus 400, a development roller 501, and a primary transfer roller 503. In the following description, the image forming units 500Y, 500M, 500C, and 500K are also collectively described as the image forming unit 500.

The photoreceptor 4 is rotationally driven in a counterclockwise direction in the drawing at the time of image formation. The charge roller 502 charges the surface of the rotating photoreceptor 4 to a uniform potential. The optical scanning apparatus 400 forms an electrostatic latent image on the photoreceptor 4 by repeatedly scanning, in the main scanning direction, the rotating photoreceptor 4 with scanning light 208 based on image data. The main scanning direction is a direction parallel to the rotation axis of the photoreceptor 4 and in which the scanning light 208 moves. A direction orthogonal to the main scanning direction and in which the scanning lines are sequentially formed is referred to as a sub-scanning direction. In the photoreceptor 4, an opposite direction to the rotation direction of the photoreceptor 4 corresponds to the sub-scanning direction. The development roller 501 develops an electrostatic latent image of the photoreceptor 4 with toner to form a toner image on the photoreceptor 4. The primary transfer roller 503 transfers the toner image on the photoreceptor 4 to the intermediate transfer body 504. The intermediate transfer body 504 is rotationally driven in a clockwise direction in the drawing at the time of image formation. Therefore, the toner image on the intermediate transfer body 504 is conveyed to an opposing position to a secondary transfer roller 506. The secondary transfer roller 506 transfers the toner image on the intermediate transfer body 504 to the sheet conveyed along a conveyance path 505. Subsequently, the sheet is conveyed to a fixing unit (not illustrated) where fixing of the toner image is performed. After the toner image is fixed, the sheet is discharged to the outside of the image forming apparatus.

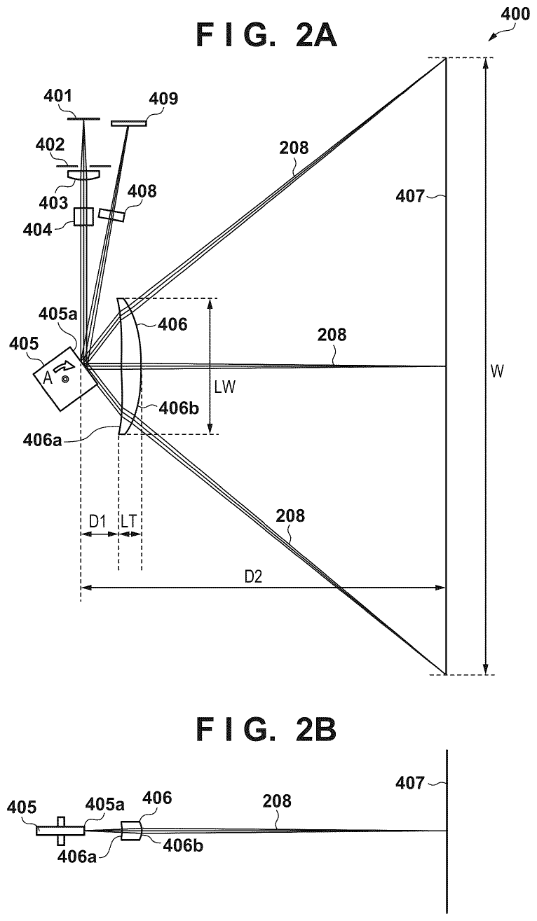

FIG. 2 is a configuration diagram of the optical scanning apparatus 400 according to the present embodiment. In FIG. 2A, a direction from the top toward the bottom corresponds to the main scanning direction, and in FIG. 2B, a direction perpendicular to the paper surface corresponds to the main scanning direction. The scanning light (light flux) 208 output from a light source 401 is shaped into an elliptical shape by an aperture stop 402 and is incident on a coupling lens 403. The scanning light 208 having passed through the coupling lens 403 is converted into substantially parallel light and is incident on an anamorphic lens 404. The anamorphic lens 404 has positive refractive power in a main-scanning cross section, and converts the incident scanning light 208 into convergent light in the main-scanning cross section. The anamorphic lens 404 condenses a light flux in a vicinity of a reflecting surface 405a of a deflector 405 in a sub-scanning cross section, and forms a long line image in the main scanning direction.

The scanning light 208 having passed through the anamorphic lens 404 is reflected by the reflecting surface 405a of the deflector (rotary polygon mirror) 405. The scanning light 208 reflected by the reflecting surface 405a is transmitted through an image forming lens 406 to form a light spot on the surface (scanned surface 407) of the photoreceptor 4. By rotating the deflector 405 at a constant angular velocity in the arrow A direction by a driving unit (not illustrated), the light spot moves in the main scanning direction on the scanned surface 407 of the photoreceptor 4, and the scanned surface 407 is scanned.

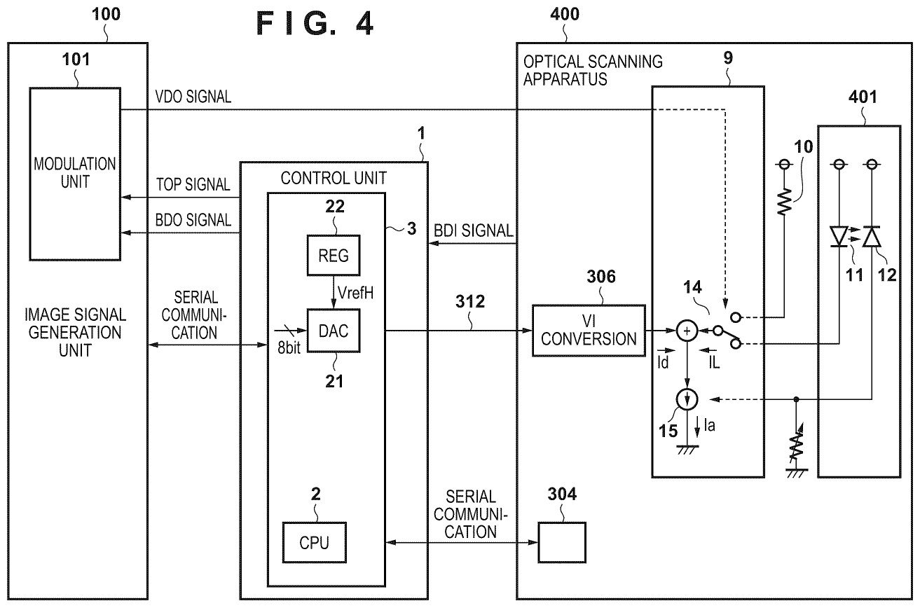

Abeam detection (hereinafter, described as BD) sensor 409 and a BD lens 408 are a synchronization optical system that determines the timing at which an electrostatic latent image is written on the scanned surface 407. The BD sensor 409 detects the scanning light 208 reflected in a predetermined direction by the deflector 405. The BD sensor 409 outputs a BDI signal (beam detection signal) indicating the detection timing of the scanning light 208 to a control unit 1 (FIG. 4). The control unit 1 outputs a BDO signal to an image signal generation unit 100 (FIG. 4) based on the BDI signal. The BDO signal is a reference timing for determining a horizontal synchronization signal, that is, “scanning start timing”. In the present embodiment, the BD lens 408 is used, but a configuration in which the BD lens 408 is not used is also possible.

The image forming lens 406 in the present embodiment does not have a so-called fθ characteristic. Therefore, even if the deflector 405 is rotated at an equiangular velocity, the scanning speed does not become constant. That is, in the optical scanning apparatus 400 of the present embodiment, the scanning speed changes depending on the position (image height) in the main scanning direction of the photoreceptor 4. More specifically, in the optical scanning apparatus 400 of the present embodiment, the scanning speed of an end portion is faster than that of a center portion in the main scanning direction of the photoreceptor 4. Use of the image forming lens 406 not having the fθ characteristic can reduce a distance D1 between the image forming lens 406 and the deflector 405. The image forming lens 406 not having the fθ characteristic can reduce a length LW in the main scanning direction and a thickness LT in an optical axis direction as compared with the image forming lens having the fθ characteristic. That is, use of the image forming lens 406 not having the fθ characteristic can downsize the optical scanning apparatus 400.

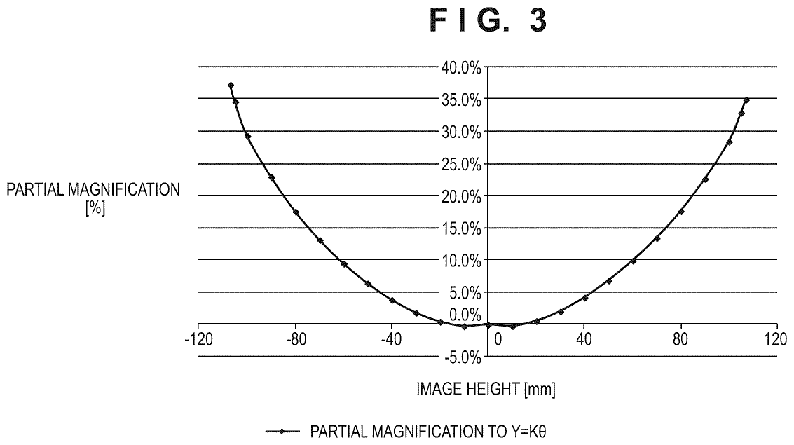

FIG. 3 illustrates an example of a relationship between the image height of the scanning light 208 and partial magnification according to the present embodiment. The partial magnification is a ratio of the scanning speed at each image height to the scanning speed when the image height is 0. The image height of 0 is a case where the light spot is on the optical axis of the image forming lens 406, and is also referred to as an on-axis image height in the following description. An image height other than the on-axis image height is referred to as an off-axis image height. Furthermore, an image height corresponding to an end portion of a scanning line is referred to as a maximum off-axis image height. In the example of FIG. 3, the scanning speed at the on-axis image height is the lowest, and the scanning speed increases as the absolute value of the image height increases. Therefore, if a pixel width in the main scanning direction is determined at a constant time interval, the pixel width differs between the on-axis image height and the off-axis image height. In order to suppress fluctuation of the pixel width due to the image height, in the present embodiment, partial magnification correction (first correction control) described later is performed.

In the optical scanning apparatus 400 of the present embodiment, the scanning speed increases as approaching the maximum off-axis image height. Therefore, when the emission luminance of the light source 401 is constant, the total exposure amount per unit length decreases as approaching the maximum off-axis image height. In order to suppress the difference in the total exposure amount per unit length due to the image height, in the present embodiment, exposure amount correction (second correction control) described later is performed in addition to the partial magnification correction.

FIG. 4 illustrates an exposure control configuration in the image forming apparatus. A modulation unit 101 of the image signal generation unit 100 receives image data from a host computer (not illustrated) and generates a VDO signal, which is an image signal. The VDO signal is, for example, a pulse width modulation (PWM) signal. The control unit 1 controls the entire image forming apparatus. The control unit 1 also controls the optical scanning apparatus 400 to control the emission luminance (emission intensity) of the light source 401. The optical scanning apparatus 400 controls on/off of light emission of the light source 401 based on the VDO signal.

After receiving a notification that generation of the VDO signal is completed from the image signal generation unit 100 by serial communication, the control unit 1 transmits a TOP signal, which is a vertical synchronization signal, and a BDO signal, which is a horizontal synchronization signal, to the image signal generation unit 100. The TOP signal is a synchronization signal in the sub-scanning direction, and the BDO signal is a synchronization signal in the main scanning direction. The control unit 1 generates the BDO signal based on the BDI signal received from the optical scanning apparatus 400. At a scanning start timing after a predetermined period (first period) from the reception of the BDO signal, the image signal generation unit 100 outputs the VDO signal to the optical scanning apparatus 400. The first period is set so that the scanning position in the main scanning direction by the scanning light 208 at the scanning start timing after the first period from the reception of the BDO signal becomes a target position for starting the scanning. Details of the configurations of the image signal generation unit 100, the control unit 1, and the optical scanning apparatus 400 illustrated in FIG. 4 will be described later.

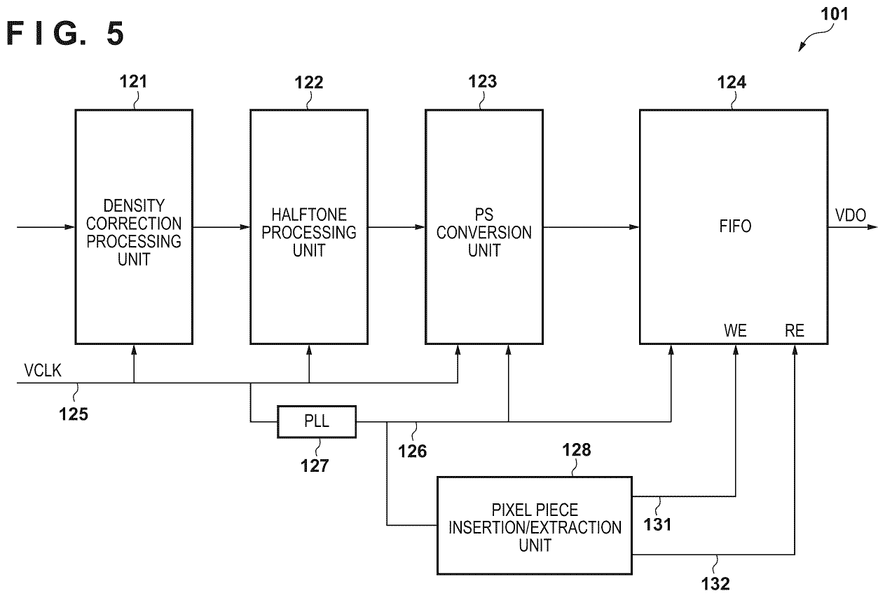

FIG. 5 is a block diagram of the modulation unit 101 of the image signal generation unit 100. A density correction processing unit 121 performs density correction processing on image data received from a host computer (not illustrated). Specifically, the density correction processing unit 121 holds a density correction table. The density correction table is information indicating a relationship between an input pixel value and an output pixel value. By referring to the density correction table with the pixel value of each pixel indicated by the received image data as an input pixel value, the density correction processing unit 121 outputs a corresponding output pixel value to a halftone processing unit 122. Correction by the density correction table is so-called gamma correction.

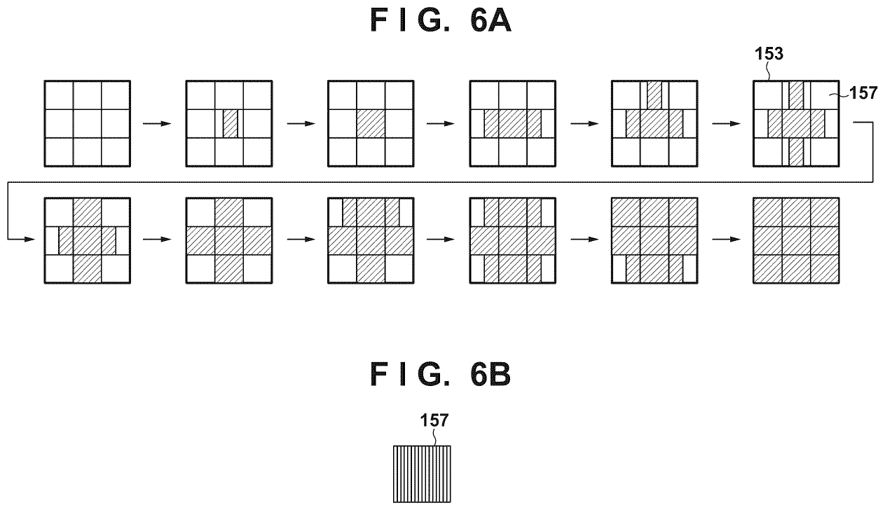

The halftone processing unit 122 performs halftone (screen) processing of image data to be input. FIG. 6A is an explanatory view of an example of the halftone processing performed by the halftone processing unit 122. In the example of FIG. 6A, density expression is performed with a matrix 153 with 200 lines of 3 pixels in each of the main scanning direction and the sub-scanning direction. Reference sign 157 indicates one pixel. A white portion in the drawing is a non-exposure region that is not an exposure target, and a black portion is an exposure region that is an exposure target. FIG. 6A illustrates that the exposure region increases with an increase in gradation. As illustrated in FIG. 6B, one pixel 157 is divided into a plurality of pixel pieces in the main scanning direction. In the example of FIG. 6B, one pixel is divided into 16 pixel pieces. In the present embodiment, an exposure region or a non-exposure region is set in units of pixel pieces. A parallel-serial (PS) conversion unit 123 converts a parallel signal input from the halftone processing unit 122 into a serial signal. The serial signal output from the PS conversion unit 123 is a PWM signal, and one pulse corresponds to one pixel piece. The corresponding pixel piece is exposed when the pulse is at a high level, for example, and the corresponding pixel piece is not exposed when the pulse is at a low level.

A phase locked loop (PLL) 127 generates an image clock 126 based on a clock (VCLK) 125 and outputs the image clock 126 to the PS conversion unit 123, a first in/first out (FIFO) 124, and a pixel piece insertion/extraction unit 128. The VCLK 125 is input also to the density correction processing unit 121, the halftone processing unit 122, and the PS conversion unit 123.

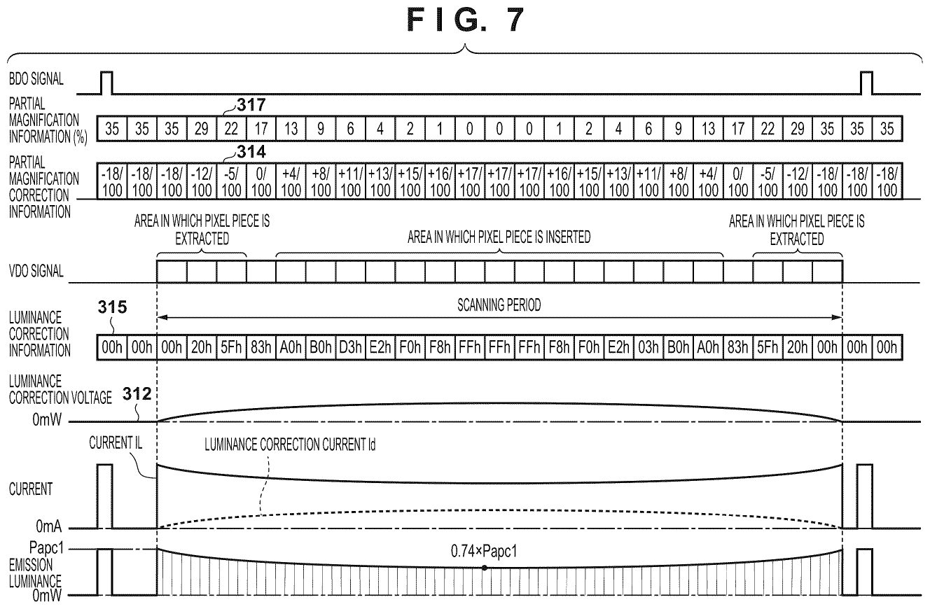

In the present embodiment, the partial magnification correction is performed by inserting/removing the above-described pixel piece in accordance with the position in the main scanning direction of the pixel. Therefore, in the present embodiment, the pixel piece insertion/extraction unit 128 is provided. By inserting/removing the pixel piece (pulse of the PWM signal) based on partial magnification correction information 314 (FIG. 7), the pixel piece insertion/extraction unit 128 suppresses the length in the main scanning direction of each pixel from changing even if the scanning speed changes depending on the image height. For partial magnification correction, the pixel piece insertion/extraction unit 128 controls a write enable (WE) signal 131 and a read enable (RE) signal 132 to be output to the FIFO 124. The FIFO 124 fetches the serial signal from the PS conversion unit 123 only when the WE signal 131 is “high level”. When extracting a pixel piece for partial magnification correction, the pixel piece insertion/extraction unit 128 sets the WE signal 131 to “low level”. The FIFO 124 accumulates, into a buffer, the data fetched from the PS conversion unit 123. The FIFO 124 reads accumulated data in synchronization with the image clock 126 only when the RE signal 132 is “high level”, and outputs the data as a VDO signal. When inserting a pixel piece for partial magnification correction, the pixel piece insertion/extraction unit 128 sets the RE signal 132 to “low level”. Due to this, the FIFO 124 does not update the output data, and continuously outputs the data corresponding to the previous pixel piece. That is, the pixel piece to be inserted is the same as the pixel piece by one on the upstream side in the main scanning direction. Since the FIFO 124 reads the accumulated data in synchronization with the image clock 126, the frequency of the VDO signal, which is an image signal, matches the frequency of the image clock 126.

In the present embodiment, the exposure amount correction is performed by controlling the emission luminance (intensity) of the light source 401. Therefore, in the following description, the term “luminance correction” is used in place of the term “exposure amount correction”. Hereinafter, the control configuration of the emission luminance of the light source 401 will be described with reference to FIG. 4. The control unit 1 includes an IC 3 incorporating a CPU 2, an 8-bit digital-to-analog converter (DAC) 21, and a regulator (REG) 22. The optical scanning apparatus 400 includes a memory 304, a VI conversion circuit 306 that converts a voltage into a current, a driver IC 9, the light source 401, and a dummy resistor 10.

The memory 304 stores partial magnification information 317 (FIG. 7) and luminance correction information 315 (FIG. 7) indicating a correction value of the current supplied to the light source 401. The IC 3 sets the voltage that the REG 22 outputs to the DAC 21. This voltage is a reference voltage of the DAC 21. Next, the IC 3 sets input data of the DAC 21 based on the luminance correction information 315 stored in the memory 304, and causes the DAC 21 to output a luminance correction voltage 312 in synchronization with the BDO signal. The VI conversion circuit 306 converts this luminance correction voltage 312 into a luminance correction current Id and outputs the luminance correction current Id to the driver IC 9.

The driver IC 9 controls on/off of light emission of the light source 401 by controlling the switch 14 based on the VDO signal and switching whether to flow the current IL through a light emission unit 11 of the light source 401 or to flow through the dummy resistor 10. The current value of the current IL is obtained by subtracting the current value of the luminance correction current Id output by the VI conversion circuit 306 from the current value of a current Ia flowing through a constant current circuit 15. The current value of the current Ia flowing through the constant current circuit 15 is feedback-controlled so that the emission luminance of the light source 401 becomes a predetermined value based on a value detected by a photodetector 12 provided in the light source 401. This feedback control is performed, for example, when the current value of the luminance correction current Id is 0.

In this manner, the current value of the current IL can be changed by controlling the value of the luminance correction current Id by the input data to the DAC 21. The emission luminance of the light source 401 can be adjusted by controlling the current value of the current IL flowing through the light emission unit 11 of the light source 401. The luminance correction is performed by adjusting the emission luminance in accordance with the image height.

FIG. 7 is a timing chart for explaining partial magnification correction and luminance correction according to the present embodiment. As described above and illustrated in FIG. 7, the VDO signal is output after the first period from the BDO signal. In FIG. 7, the scanning period is a period in which the photoreceptor 4 is scanned only once with the scanning light, and the left end of the scanning period in the drawing corresponds to the scanning start timing.

The partial magnification information 317 indicates a change rate of the scanning speed at each image height with respect to the reference scanning speed. The reference scanning speed in the example of FIG. 7 is the scanning speed at the on-axis image height. In the present embodiment, the main scanning direction is divided into a plurality of sections, and the partial magnification information indicates the partial magnification of each section. The partial magnification in the section near the on-axis image height is 0. The partial magnification increases toward the end portion of the scanning line, and the partial magnification at the maximum off-axis image height is 35%.

The CPU 2 of the control unit 1 reads the partial magnification information 317 from the memory 304 via serial communication, generates the partial magnification correction information 314 based on the partial magnification information 317, and notifies the pixel piece insertion/extraction unit 128 of the modulation unit 101 of the partial magnification correction information 314. The partial magnification correction information 314 can be stored in the memory 304 in advance. Furthermore, the partial magnification information 317 or the partial magnification correction information 314 can be stored in the image signal generation unit 100 in advance.

The partial magnification correction information 314 of FIG. 7 indicates the number of pixel pieces to be inserted or extracted for every 100 pixel pieces. A negative value indicates that a pixel piece is extracted, and a positive value indicates that a pixel piece is inserted. The partial magnification correction information 314 of FIG. 7 indicates that 17 pixel pieces are inserted for every 100 pixel pieces in the section near the on-axis image height, and 18 pixel pieces are extracted for every 100 pixel pieces in the section near the maximum off-axis image height.

The CPU 2 reads the luminance correction information 315 from the memory 304. Similarly to the partial magnification information 317, the luminance correction information 315 is provided for each section in the main scanning direction, and is information for determining a value to be set to the input of the DAC 21 when the section is scanned with the scanning light 208. The DAC 21 outputs the luminance correction voltage 312 in accordance with the input data, and hence the VI conversion circuit 306 outputs, to the driver IC 9, the luminance correction current Id of the current value in accordance with the voltage value of the luminance correction voltage 312. As described above, as the luminance correction current Id changes, the current IL changes, and the emission luminance of the light source 401 also changes. In the example of FIG. 7, the luminance correction information 315 is set such that the luminance correction voltage 312 is the smallest at the maximum off-axis image height and is the largest near the on-axis image height. Therefore, the current IL is the largest at the maximum off-axis image height and is the smallest near the on-axis image height. In FIG. 7, Papc1 denotes the emission luminance of the light source 401 when the luminance correction current Id is 0. As illustrated in FIG. 7, the emission luminance of the light source 401 at the on-axis image height is 0.74 times the emission luminance of the light source 401 at the maximum off-axis image height. This is because the scanning speed at the on-axis image height is 1/1.35≈0.74 times the scanning speed at the maximum off-axis image height.

In this manner, in the present embodiment, the partial magnification correction (first correction control) and the luminance correction (second correction control) are performed. The partial magnification correction is to correct the scanning time for forming one pixel in accordance with the position in the main scanning direction so that the width of the pixel formed on the photoreceptor 4 by the scanning light 208 becomes a predetermined value. The luminance correction is to correct the exposure amount of the pixel formed by the scanning light 208 in accordance with the position in the main scanning direction so that the density of the pixel formed on the photoreceptor 4 by the scanning light 208 becomes the density corresponding to the pixel value of the pixel.

The partial magnification correction information 314 is used in the partial magnification correction, and the luminance correction information 315 is used in the luminance correction. The partial magnification correction information 314 is information indicating the relationship between the position or section in the main scanning direction and the insertion/extraction amount of the pixel piece. The luminance correction information 315 is information indicating the relationship between the position or section in the main scanning direction and the correction amount of the emission luminance of the light source 401. This configuration can perform exposure in which image defects are suppressed even when scanning is performed without using a scanning lens having the fθ characteristic.

In the partial magnification correction information 314 illustrated in FIG. 7, the pixel piece is inserted near the on-axis image height, and the pixel piece is extracted near the maximum off-axis image height. However, the insertion/extraction amount of the pixel piece at the on-axis image height can be 0, and the extraction amount of the pixel piece can be increased as approaching the maximum off-axis image height. Inversely, the insertion/extraction amount of the pixel piece at the maximum off-axis image height can be 0, and the insertion amount of the pixel piece can be increased as approaching the on-axis image height. The smaller the maximum value of the absolute value of the insertion/extraction amount of the pixel piece is, the better the image quality becomes.

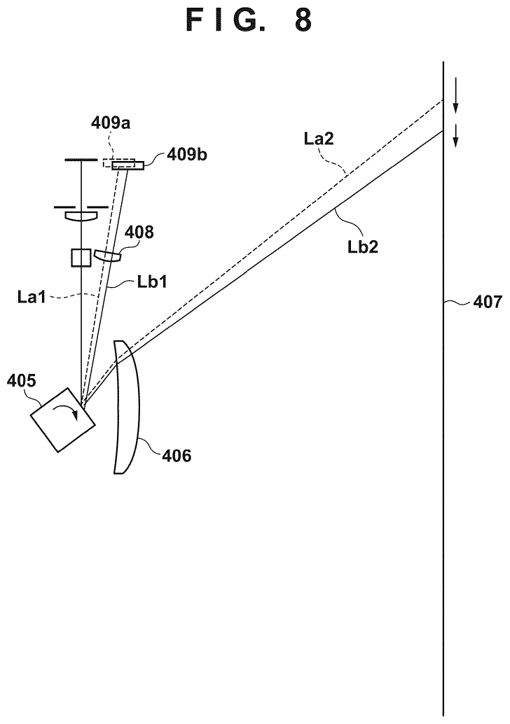

Subsequently, an example of a cause of an error occurring in the BDI signal output from the BD sensor 409 will be described. A BD sensor 409b in FIG. 8 illustrates the BD sensor 409 actually arranged in the optical scanning apparatus 400. A BD sensor 409a indicates the BD sensor 409 arranged in an ideal state. In FIG. 8, reference sign La1 denotes the scanning light 208 incident on the BD sensor 409a, and reference sign Lb1 denotes the scanning light 208 incident on the BD sensor 409b. As illustrated in FIG. 8, the timing at which the scanning light 208 is incident on the BD sensor 409b is later than the timing at which the scanning light 208 is incident on the BD sensor 409a arranged in the ideal state. That is, in FIG. 8, the timing at which the BD sensor 409b outputs the BDI signal is later than the ideal timing.

Since the BDI signal is delayed from the ideal timing, the BDO signal is also delayed from the ideal timing, whereby the actual scanning start position is shifted to the downstream side in the scanning direction with respect to the target position. An intersection of a light beam La2 and the scanned surface 407 of the photoreceptor 4 in FIG. 8 is the target position for scanning start, and an intersection of a light beam Lb2 and the scanned surface 407 is an actual scanning start position. The deviation of the BDI signal occurs not only due to an attachment error of the BD sensor 409 but also due to an attachment error of the BD lens 408. A slit may be provided on the upstream side of the BD sensor 409, but an error occurs in the BDI signal even if the slit position deviates.

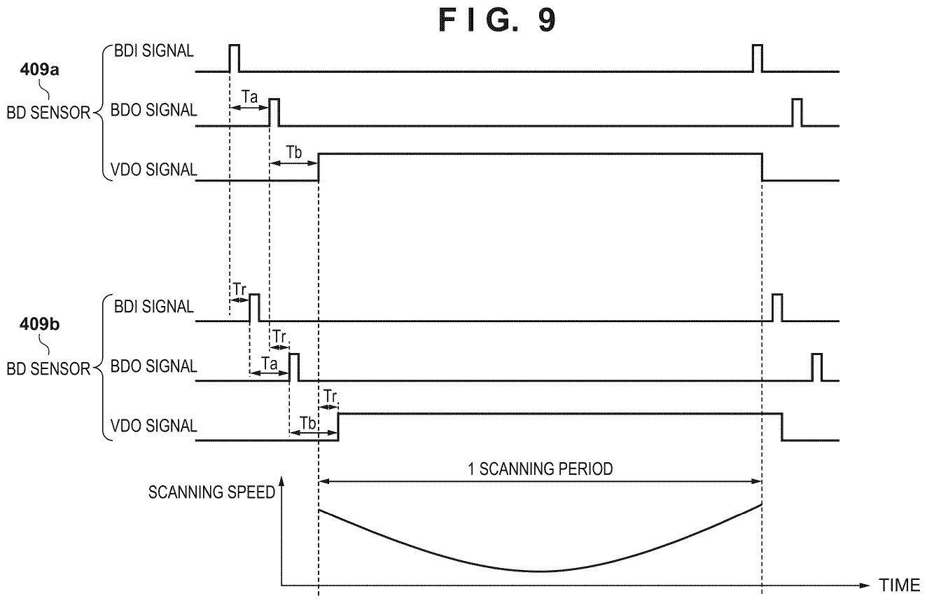

FIG. 9 illustrates relationships among the BDI signal, the BDO signal, and the VDO signal based on the BD sensor 409a and the BDI signal, the BDO signal, and the VDO signal based on the BD sensor 409b. The BDO signal is output after a predetermined period Ta has elapsed from the timing of the BDI signal, and the VDO signal is output after a predetermined period Tb has elapsed from the timing of the BDO signal. That is, the timing at which the period Tb has elapsed from the timing of the BDO signal is the scanning start timing. According to FIG. 9, the output timing of the BDI signal by the BD sensor 409b is delayed by a period Tr from the output timing of the ideal BDI signal output by the BD sensor 409a. Therefore, in the case of the BD sensor 409b, the timing at which the BDO signal and the VDO signal are output is delayed by the period Tr from the ideal timing.

FIG. 9 also illustrates a change in the scanning speed in one scan of the photoreceptor 4 based on the partial magnification characteristic. As described above, in the partial magnification correction, the number of insertion/extraction of pixel pieces is changed in accordance with the scanning speed. Here, when the output timing of the BDO signal is ideal, the VDO signal is output at the ideal scanning start timing, and thus, the scanning position of the light beam 208 at that time is the target position. Therefore, the partial magnification correction can be accurately performed based on the partial magnification correction information 314. On the other hand, when the output timing of the BDO signal is delayed from the ideal timing, the actual scanning start position is on the downstream side of the target position. In this case, the modulation unit 101 performs the partial magnification correction on the assumption that the scanning start position is the target position even though the actual scanning start position is on the downstream side of the target position.

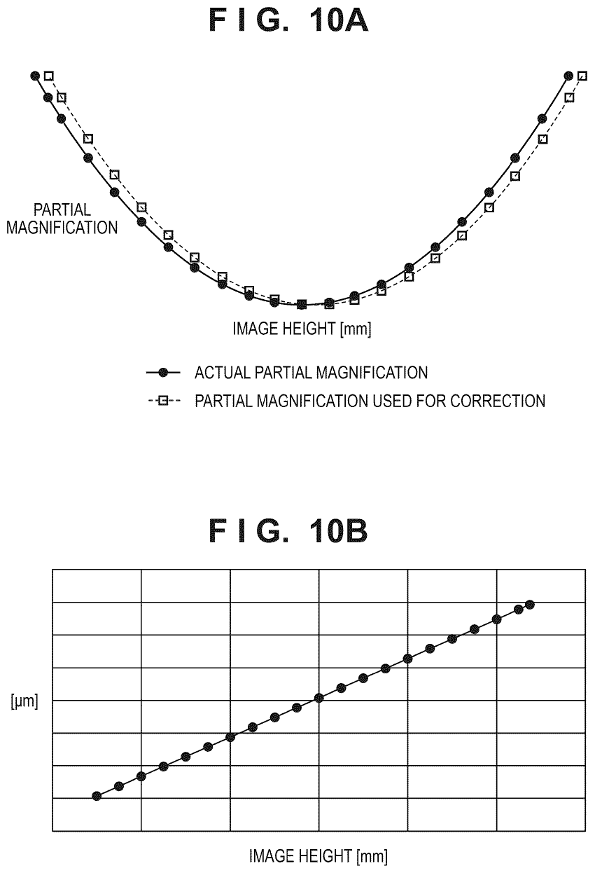

FIG. 10A shows this state. In FIG. 10, the solid lines indicate the actual partial magnification, and the dotted line indicates the partial magnification used for correction in a case where the output timing of the BDO signal is delayed from the ideal timing. As illustrated in FIG. 10A, the partial magnification used for correction is higher than the actual partial magnification on the upstream side of the scanning line. As a result, the pixel piece is excessively extracted on the upstream side of the scanning line, and the width of the pixel becomes shorter than the target width. On the other hand, the partial magnification used for correction is lower than the actual partial magnification on the downstream side of the scanning line. As a result, the extraction of the pixel piece is insufficient on the downstream side of the scanning line, and the width of the pixel becomes longer than the target width. FIG. 10B shows a difference for each image height between the width of the pixel formed when the output timing of the BDO signal is delayed from the ideal timing and the target value. The same applies to the exposure amount correction (luminance correction), and the correction of the exposure amount in accordance with the scanning speed is no longer performed as the output timing of the BDO signal deviates.

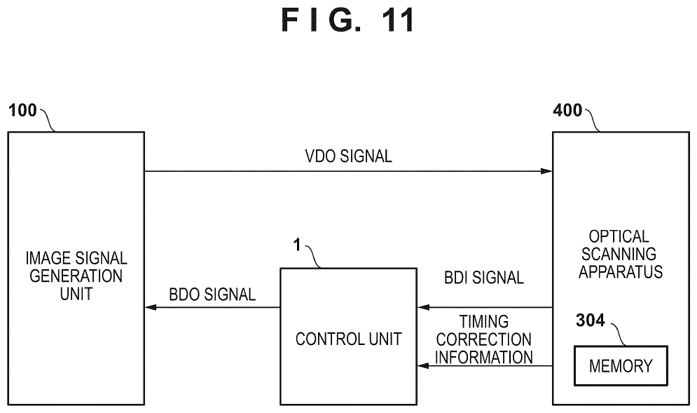

FIG. 11 illustrates the exposure control configuration according to the present embodiment for correcting the deviation in the timing of the BDO signal. The memory 304 of the optical scanning apparatus 400 stores, in addition to the partial magnification information 317 and the luminance correction information 315, timing correction information indicating a deviation amount (correction value) from the ideal timing of the BDI signal.

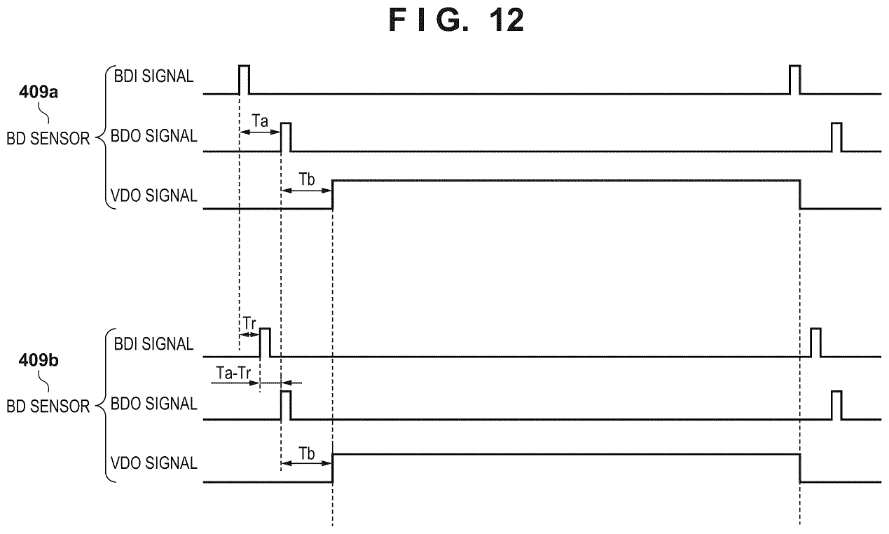

For example, in the example of FIG. 9, the correction value in the case of the BD sensor 409b is Tr. The timing correction information is measured individually for the optical scanning apparatuses 400 before shipment from the factory and stored in the memory 304. The control unit 1 acquires, from the memory 304, the correction value indicated by the timing correction information. Then, the control unit 1 corrects a reference period Ta (FIG. 9) from reception of the BDI signal to output of the BDO signal with a correction value and obtains a correction period. For example, when the correction value is Tr, the correction period is (Ta-Tr). The control unit 1 outputs the BDO signal at a timing after the correction period (Ta-Tr) from the reception timing of the BDI signal. Therefore, as illustrated in FIG. 12, even if the timing of the BDI signal is different from the ideal timing, the output timing of the BDO signal can be brought close to the ideal timing. Therefore, the scanning start timing (output timing of the VDO signal) can also be brought close to the ideal timing. Therefore, an error between the scanning start position and the target position can be reduced, and thus the partial magnification correction and the luminance correction can be accurately performed.

### Additional Notes

In the present embodiment, the partial magnification correction is performed by insertion/extraction of pixel pieces, and the exposure amount correction is performed by the luminance correction. Here, as the exposure amount correction, the density correction described below can be used in place of the above-described luminance correction. Furthermore, the partial magnification correction can also be performed by correcting the frequency of the image clock 126 (hereinafter, described as frequency correction) in place of the insertion/extraction of the pixel piece described above.

First, the density correction will be described. The density correction is to correct the pixel value of each pixel in accordance with the image height in order to correct the exposure amount of the pixel. When the density correction is performed, luminance correction is not performed, and thus the luminance correction information 315 is not stored in the memory 304 of the optical scanning apparatus 400. The current value of the current IL flowing through the light source 401 is controlled to be constant during one scan. Therefore, electric circuits such as the DAC 21, the REG 22, and the VI conversion circuit 306 for performing luminance correction are unnecessary.

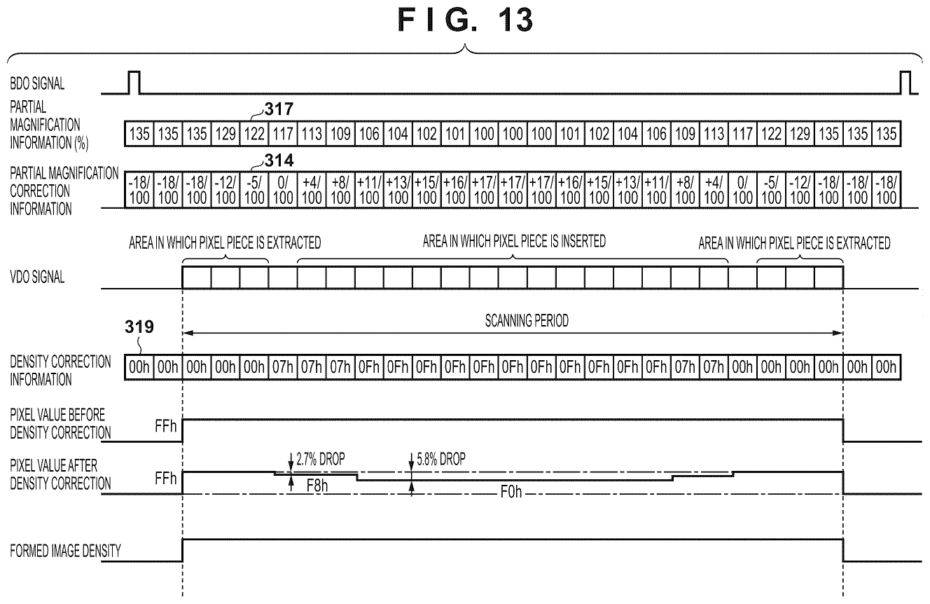

When the density correction is performed, density correction information 319 (FIG. 13) is stored in the memory 304 of the optical scanning apparatus 400. The density correction information 319 is information indicating the relationship between the position or section in the main scanning direction and the correction amount of the pixel value. The correction amount of the pixel value is set so as to increase the decrease amount as the scanning speed decreases. The CPU 2 of the control unit 1 reads the density correction information 319 stored in the memory 304, and outputs the density correction information 319 to the modulation unit 101 of the image signal generation unit 100. The density correction processing unit 121 of the modulation unit 101 performs density correction processing based on the density correction information 319. Specifically, the pixel value (gradation value) of the pixel is changed based on the density correction information.

FIG. 13 is a timing chart of the partial magnification correction and the density correction. Parts related to the partial magnification correction are similar to those in FIG. 7. The density correction information 319 indicates the position of the pixel in the main scanning direction and the decrease amount of the pixel value of the pixel. Specifically, in a case where the correction value is “07h” in FIG. 13, the density correction processing unit 121 outputs a value in which the pixel value before the density correction is subtracted by 7, and in a case where the correction value is “0Fh”, outputs a value in which the pixel value before the density correction is subtracted by 15. The “pixel value before the density correction” means an output pixel value indicated by the density correction table. That is, the density correction processing unit 121 converts the input pixel value into the output pixel value based on the density correction table, and corrects the output pixel value based on the density correction information 319. As illustrated in FIG. 13, in a case where the pixel value before the density correction is 255 (FFh), the pixel value of the pixel near the on-axis image height output by the density correction processing unit 121 is 240 (F0h). Therefore, the decrease amount of the density is 15/255≈5.8%. In the density correction information 319 of FIG. 13, the density is not decreased in the maximum off-axis image height, and the density is decreased by about 5.8% in the on-axis image height. When the density correction is not performed in a case where the scanning speed at the maximum off-axis image height is 135% of the on-axis image height, the image density at the on-axis image height does not necessarily become 135% of the image density at the maximum off-axis image height. This is because the relationship between the total exposure amount per unit area of the photoreceptor 4 and the toner density of the finally formed image is not linear due to the exposure sensitivity characteristic of the photoreceptor 4 and the development characteristic of the toner. The density correction information 319 is set in consideration of such circumstances.

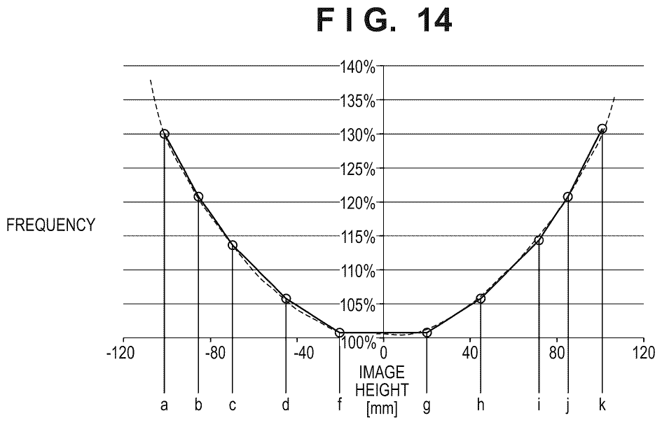

Next, frequency correction will be described. FIG. 14 shows an example of frequency correction information used for frequency correction. FIG. 14 shows the frequency at each image height as a ratio to the frequency at the on-axis image height. In the example of FIG. 14, the main scanning direction is divided into nine sections. Characters “a” to “k” in FIG. 14 denote positions in the main scanning direction that is end portions of the respective sections. An ideal frequency for correcting the partial magnification at a position in the main scanning direction that is an end portion of each section is set with respect to the position. In this manner, the frequency correction information is information indicating the end portion position of each section in the main scanning direction and the frequency at the end portion position, and is stored in the memory 304 in advance.

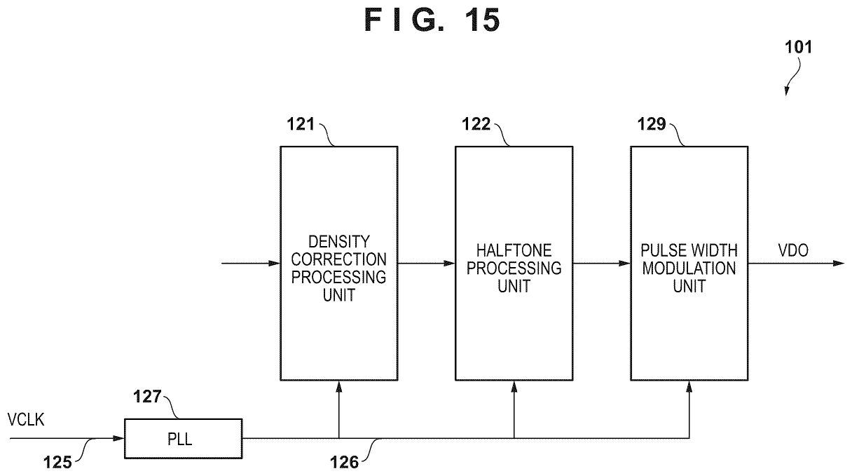

FIG. 15 is a configuration diagram of the modulation unit 101 in a case where the partial magnification correction is performed by the frequency correction. When the scanning light 208 is scanning the end portion position of each section, the PLL 127 generates the image clock 126 based on the VCLK 125 so as to have a frequency indicated by the frequency correction information. When a position other than the end portion position of the section is scanned, the modulation unit 101 sequentially changes the parameter to be given to the PLL 127 so that the frequency of the image clock 126 becomes the frequency obtained by linearly interpolating the frequencies of the two end portion positions of the section. A pulse width modulation unit 129 outputs the VDO signal in accordance with the image clock 126 based on the image data output from the halftone processing unit 122. The fluctuation in the pixel width due to the fluctuation in the scanning speed can be suppressed by controlling the frequency of the VDO signal (image signal) in accordance with the partial magnification, that is, the scanning speed.

While the embodiment has been described using a color image forming apparatus, the above embodiment can also be applied to a monochrome image forming apparatus. As described above, when the scanning speed changes in accordance with the image height, the partial magnification correction and the exposure amount correction are performed, but when the timing of the BDO signal (horizontal synchronization signal) deviates from the ideal timing, the accuracy of the partial magnification correction and the exposure amount correction deteriorates. In the above embodiment, the timing of the BDO signal is brought close to the ideal timing based on the timing correction information, whereby the accuracy of the partial magnification correction and the exposure amount correction is suppressed from deteriorating. Therefore, even in the monochrome image forming apparatus, when the scanning speed changes in accordance with the image height, it is possible to suppress deterioration of the accuracy of the partial magnification correction and the exposure amount correction according to the above embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-101182, filed Jun. 20, 2023, which is hereby incorporated by reference herein in its entirety.

What is claimed is:

1. An image forming apparatus comprising:
a photoreceptor that is rotationally driven;
an image signal generation unit configured to generate an image signal based on image data;
an optical scanning apparatus configured to scan the photoreceptor with a light beam having a scanning speed changing in accordance with a position in a main scanning direction, the optical scanning apparatus configured to form an electrostatic latent image on the photoreceptor by scanning the photoreceptor in the main scanning direction with a light beam corresponding to the image signal generated by the image signal generation unit; and
a control unit configured to output, to the image signal generation unit, a horizontal synchronization signal for determining a timing at which the image signal generation unit outputs the image signal to the optical scanning apparatus, wherein
the optical scanning apparatus includes
a light source that emits the light beam,
a rotary polygon mirror for scanning the photoreceptor in the main scanning direction by the light beam emitted by the light source,
a beam detection sensor that detects the light beam reflected by the rotary polygon mirror and outputs, to the control unit, a beam detection signal indicating a detection timing of the light beam, and
a memory that stores timing correction information indicating a deviation amount of an output timing of the beam detection signal, and
the control unit corrects, based on the timing correction information acquired from the memory, a reference time from reception of the beam detection signal from the beam detection sensor to output of the horizontal synchronization signal, and outputs the horizontal synchronization signal to the image signal generation unit at a timing after a period corrected from reception of the beam detection signal.

2. The image forming apparatus according to claim 1, wherein the timing correction information indicates a difference between a timing at which the beam detection sensor detects the light beam and a reference timing at which the beam detection sensor should detect the light beam.

3. The image forming apparatus according to claim 1, wherein the control unit or the image signal generation unit executes, with reference to the horizontal synchronization signal, first correction control of correcting a change in a pixel width due to a change in the scanning speed and second correction control of correcting a change in an exposure amount due to a change in the scanning speed.

4. The image forming apparatus according to claim 3, wherein the image data is data indicating whether or not to expose each pixel piece in which one pixel is divided, and
the first correction control is a control of extracting data of the pixel piece indicated by the image data or inserting data of the pixel piece into the image data in accordance with the scanning speed in order to correct a change in the pixel width due to a change in the scanning speed.

5. The image forming apparatus according to claim 3, wherein the image signal generation unit outputs the image signal to the optical scanning apparatus in accordance with an image clock, and
the first correction control is a control of changing a frequency of the image clock in accordance with the scanning speed in order to correct a change in the pixel width due to a change in the scanning speed.

6. The image forming apparatus according to claim 3, wherein the second correction control is a control of changing emission luminance of the light source of the optical scanning apparatus in accordance with the scanning speed in order to correct a change in the exposure amount due to a change in the scanning speed.

7. The image forming apparatus according to claim 3, wherein the second correction control is a control of correcting a pixel value indicated by the image data in accordance with the scanning speed in order to correct a change in the exposure amount due to a change in the scanning speed.
